(19) United States
(12) Patent Application Publication
(10) Pub. No.: US 2012/0086777 A1
(43) Pub. Date: Apr. 12, 2012

(54) SYSTEMS AND METHODS FOR DETECTING AND DISPLAYING THREE-DIMENSIONAL VIDEOS

(75) Inventors: Ji-Da CHEN, Kaohsiung City (TW); Ya-Chi Tsai, Hsinchu City (TW); Meng-Han Tsai, Hsinchu County (TW); Chi-Lin Wu, Xinbei City (TW)

(73) Assignee: Industrial Technology Research Institute

(21) Appl. No.: 12/979,941

(22) Filed: Dec. 28, 2010

Related U.S. Application Data
(60) Provisional application No. 61/391,438, filed on Oct. 8, 2010.

(51) Int. Cl. H04N 13/02

(52) U.S. Cl. 348/46; 348/E13.074

(57) ABSTRACT

A video player system includes a three-dimensional field detector and controller module for detecting a three-dimensional field of a video data to generate at least one of a detection signal and a control signal based on the three-dimensional field detected. The video data includes data for at least one image and the three-dimensional field within the image. The system also includes a display recomposition module coupled with the three-dimensional field detector and controller module, and the display recomposition module generates a recomposed three-dimensional field within the at least one image based on the detection signal and at least one of a plurality of display parameters associated with a display panel. The display panel is coupled with the three-dimensional field detector and controller module and the display recomposition module and displays the at least one image with the recomposed three-dimensional field based on at least one of the control signal and the display parameters.

### RELATED APPLICATIONS

This application claims the benefit of priority of U.S. Provisional Application No. 61/391,438, filed Oct. 8, 2010, and titled “One Multiview Player Module Including Automatic Display Information Collector, Dynamic 3D Field Rendering and Depth Adjusting Controller”, the entire contents of which are incorporated herein by reference.

### TECHNICAL FIELD

This disclosure relates in general to systems and methods for displaying three-dimensional videos and, more particularly, to systems and methods for detecting multi-view, three-dimensional video data and controlling the display based on the processed video data.

### BACKGROUND

A three-dimension (3D) image may be formed according to the concept of stereoscopic vision as observed by the two eyes of a human being. Three-dimensional image display techniques may be classified into a glass-based display technique that requires users to wear stereoscopic glasses to observe three-dimensional images; and a glass-less stereoscopic-display technique that enables users to observe three-dimensional images with naked eyes (and without wearing specialized glasses).

Multi-view, three-dimensional images can be displayed in various modes, such as a two-dimensional mode, a stereoscopic mode, and an auto-stereoscopic mode. Because each of these modes has its own data format, three-dimensional video player systems often need to provide multi-view, three dimensional video data based on the specific display modes supported by display panels. In some cases, users may manually input information relating to the supported specific display mode of a display panel.

### SUMMARY

Consistent with the disclosed embodiments, a video player system comprises a three-dimensional field detector and controller module for detecting a three-dimensional field within a at least one image of a video data to generate at least one of a detection signal and a control signal based on the three-dimensional field detected. The system also includes a display recomposition module coupled with the three-dimensional field detector and controller module, and the display recomposition module generates a recomposed three-dimensional field within the at least one image based on the detection signal and at least one of a plurality of display parameters associated with a display panel. The display panel may be coupled with the three-dimensional field detector and controller module and the display recomposition module and may display the at least one image with the recomposed three-dimensional field based on at least one of the control signal and the plurality of display parameters.

Consistent with the disclosed embodiments, a method for displaying videos includes detecting a three-dimensional field within at least one image of a video data; generating at least one of a detection signal and a control signal based on the three-dimensional field detected. The method also includes generating a recomposed three-dimensional field within the at least one image based on the detection signal and at least one of a plurality of display parameters associated with a display panel. The display panel may be coupled with the three-dimensional field detector and controller module and the display recomposition module and may display the at least one image with the recomposed three-dimensional field based on at least one of the control signal and the at least one of the plurality of display parameters.

It is to be understood that both the foregoing general description and the following detailed description are exemplary and explanatory and are not restrictive of the subject matter as claimed.

### BRIEF DESCRIPTION OF THE DRAWINGS

The accompanying drawings, which are incorporated in and constitute a part of this specification, illustrate embodiments and, together with the description, serve to explain the objects, advantages, and principles of the disclosed embodiments.

In the drawings,

FIG. 1 illustrates an exemplary video player system for dynamically detecting and displaying multi-view, three-dimensional video data consistent with the disclosed embodiments;

FIG. 2 illustrates an exemplary, functional block diagram of a video player system of FIG. 1 consistent with the disclosed embodiments;

FIG. 3 illustrates an exemplary operation of a dynamic three-dimensional field detector and controller module consistent with the disclosed embodiments.

FIG. 4 illustrates an exemplary, functional block diagram of a data recomposition module consistent with the disclosed embodiments;

FIG. 5 illustrates an exemplary functional block diagram of a display panel consistent with the disclosed embodiments;

FIGS. 6A and 6B illustrate an exemplary operation of the local dimming backlight module consistent with the disclosed embodiments;

FIG. 7 illustrates a flow chart of an exemplary method for dynamically detecting and displaying multi-view, three-dimensional video data consistent with the disclosed embodiments;

FIG. 8 illustrates a flow chart of an exemplary method for collecting display parameters correspond to a display panel consistent with the disclosed embodiments; and

FIG. 9 illustrates a flow chart of an exemplary method for dynamically detecting a display field for displaying multi-view, three-dimensional video data consistent with the disclosed embodiments.

### DESCRIPTION OF THE EMBODIMENTS

Reference will now be made in detail to the disclosed embodiments, examples of which are illustrated in the accompanying drawings. Wherever possible, the same reference numbers will be used throughout the drawings to refer to the same or like parts.

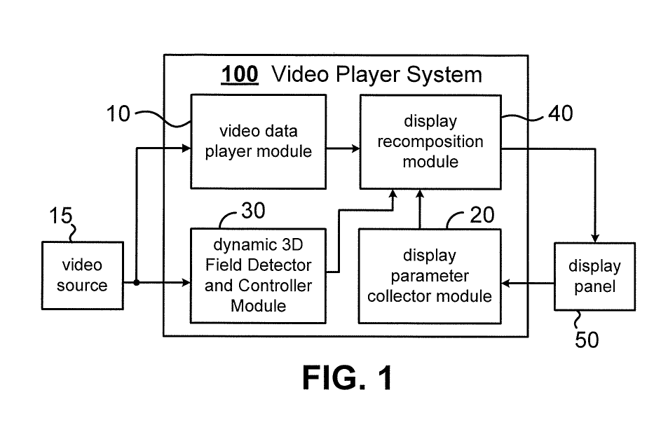

FIG. 1 illustrates a video player system for dynamically detecting and displaying multi-view, three-dimensional video data consistent with the disclosed embodiments. A video player system 100 in one embodiment includes the elements illustrated in FIG. 1 and described below. A video data player module 10 may process video data. The video data may include multiple images, and the images (individually or jointly) may include a three-dimensional field, which may have multi-view, three-dimensional video data. A display parameter collector module 20 may collect and store display parameters associated with a display panel coupled with the video player system 100. One or more of the display parameters may determine how the display panel displays multi-view, three-dimensional video data.

A three-dimensional field detector and controller module 30 may be coupled with the video data player module 10 and may detect the three-dimensional field within each image and generate a detection signal and a control signal based on the three-dimensional field detected. In one embodiment, the three-dimensional field detector may detect the three-dimensional field dynamically. A display recomposition module 40 may be coupled with the three-dimensional field detector and controller module 30 and may recompose the three-dimensional field within each image according to one or more of the display parameters associated with the display panel and the detection signal. The functional blocks of each module illustrated in FIG. 1 and their operations may follow one or more of the embodiments explained in greater detail below.

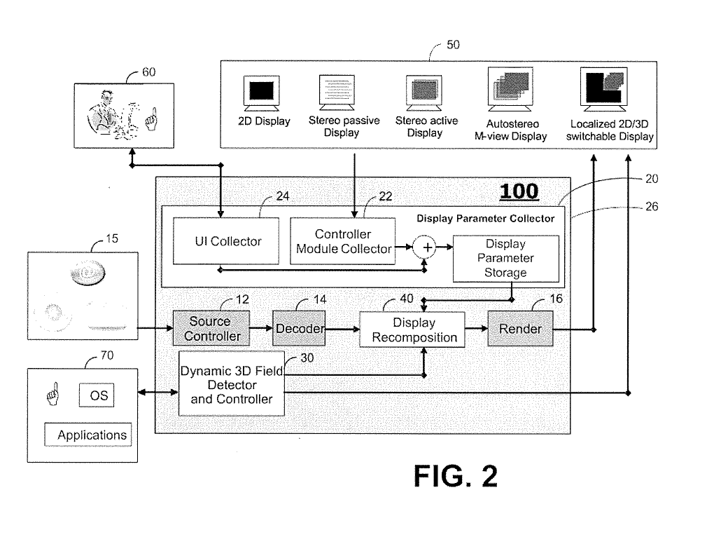

FIG. 2 illustrates a functional block diagram of a video player system of FIG. 1 consistent with the disclosed embodiments. In an embodiment, the video data player module 10 of the video player system 100 may further include a source controller 12 coupled with various video sources 15; a decoder 14 coupled with the source controller 12 and the display recomposition module 40; and a render 16 coupled with the decoder 14, the display recomposition module 40, and a display panel 50, which is coupled with the video player system 100. As described above, in this embodiment, the video data may include information for multiple images, and each image may include a three-dimensional field with multi-view, three-dimensional video data. The functional blocks of the video data player module 10 illustrated in FIG. 2 and their operations may follow one or more of the embodiments explained in greater detail below.

As shown in FIG. 2, in an embodiment, the video player system 100 may be coupled to an optical storage or playback device, such as a DVD (digital video disc) player, and the source 15 for providing the video data may be a DVD. In this embodiment, the source controller 12 of the video player system 100 may control the video data to be retrieved from the optical storage or playback device. In another embodiment, the video player system 100 may have the capability to connect to a network or the Internet so that users can receive video data by browsing websites or downloading from on-line video data providers. In this embodiment, the source controller 12 of the video player system 100 may receive the video data downloaded from internet. Still in another embodiment, the video player system 100 may be coupled to a personal computer and the video files stored in the personal computer may be provided to the video player system 100. In this embodiment, either the personal computer or the source controller 12 of the video player system 100 may control the transfer of video data so that the video data is received by the video player system 100.

In an embodiment, the video data received by the source controller 12 may be a compressed bitstream data. In this embodiment, the decoder 20 may be required to decompress the compressed bitstream data. In another embodiment, the video player system 100 may be an analog player system for receiving analog uncompressed video data. In this embodiment, the decoder 14 for decompressing the received video data may be an optional device.

Referring to FIG. 2, in an embodiment, the display panel 50 may be a localized 2D/3D switchable display, which can display both multi-view, three-dimensional video data and the conventional two-dimensional video data simultaneously. The location and the area of the three-dimensional field for displaying multi-view, three-dimensional video data on the display panel 50 can be dynamically changed. In another embodiment, the display panel 50 may be a stereoscopic type display panel so that users can observe three-dimensional video data by wearing stereoscope glasses. In this embodiment, the three-dimensional video data can be displayed in either stereo active mode or stereo passive mode. In still another embodiment, the display panel 50 may be an auto-stereoscopic type display panel so that users can observe three-dimensional video data with naked eyes (and without wearing stereoscope glasses).

The display panel 50 of FIG. 2 may be a multi-view, three-dimensional display panel for users to observe three-dimensional video data from multiple different viewpoints. In an embodiment, the number of viewpoints may be two for the stereoscopic type display panel and the number of viewpoints may be three for auto-stereoscopic type display panel. In other embodiments, the number of viewpoints of the display panel 50 can be one, two, three, or more than three based on the hardware capability of the display panel 50.

In an embodiment, the display panel 50 includes a hardware interface for coupling the display panel 50 with the video player system 100. In this embodiment, the hardware interface for use in the display panel 50 is consistent with either Digital Video Interactive (DVI) standard, High Definition Multimedia Interface (HDMI) standard, DisplayPort, Universal Series Bus (USB) standard or any other standard for transmitting/receiving video data. The render 30 of the video player system 100 is for rendering the video data, which may include images with the three-dimensional field and providing the video data to the display panel 50 in a format consistent with the specific hardware interface standard used by the display panel 50.

Referring to FIG. 2, the display parameter collector module 20 of the video player system 100 may further include: a controller module collector 22 for collecting display parameters associated with the display panel 50; a UI collector 24 for manually inputting the display parameters; and a display parameter storage 26 for storing the display parameters gathered from either the controller module collector 22 or the UI collector 24. One or more of the display parameters may determine how the display panel 50 displays multi-view, three-dimensional video data. In an embodiment, the display parameters may include, but not limited to one or more of: the display mode supported by the display panel 50, the maximum number of viewpoints supported by the display panel 50, the pixel arrangement of the multi-view, three-dimensional video data supported by the display panel 50, the range of depth (Z-axis) supported by the display panel 50 for displaying multi-view, three-dimensional video data, the size of the display panel, the native resolution of the display panel 50, the control algorithm to control the display of the display panel 50 and the format of the control signal provided by the video player system 100 to the display panel 50. These display parameters will be explained in greater detail below.

As described above, the multi-view, three-dimensional video data can be displayed in various display modes according to the type of the display panel 50. In an embodiment, the stereoscopic type display panel can display three-dimensional video data in either stereo active mode or stereo passive mode. The auto-stereoscopic mode supported by auto-stereoscopic display type panel is another three-dimensional video data display mode.

Additionally, in an embodiment, the viewpoint number of different display panel 50 coupled to the video player system 100 can be different. As described above, in an embodiment, the number of viewpoints may be larger than four for a stereoscopic type display panel 50. In another embodiment where the display panel 50 is a hand-held device, such as a mobile phone, a smart phone, a PDA (personal digital assistant), a tablet PC, etc, the number of viewpoints may be two. Still in other embodiments, the number of viewpoints can be one, two, three, or more than three based on the hardware capability of the display panel 50.

Moreover, the pixel arrangement of images with three-dimensional field supported by the display panel 50 determines how pixel data relating to each image with three-dimensional field should be provided to the display panel 50. In an embodiment, the pixel arrangement of the images with three-dimensional field may be determined based on various factors which include but not limit to the display mode supported by the display panel 50, the number of viewpoints supported by the display panel 50, and the manufacturer and/or model number of the display panel 50.

Furthermore, in an embodiment, the resolution of the images with three-dimensional field and the depth (Z-axis) of the three-dimensional field with multi-view, three-dimensional video data may be adjusted according to one or more factors, such as the size of the display panel 50, the native resolution of the display panel 50, and the resolution of the three-dimensional field to be displayed on the display panel 50. For each display panel capable of displaying multi-view, three-dimensional video data, the proper range of the depth (Z-axis) supported by the display panel 50 may be determined based upon the size and the native resolution of the display panel 50, and the three-dimensional display mode supported by the display panel 50. In addition, the proper range of the depth (Z-axis) supported by the display panel 50 may also be different for different users. Moreover, due to the constraint of current three-dimensional display technology, the proper range of the depth (Z-axis) supported by the display panel 50 may be different for different display panels 50. All these factors may be the display parameters used to determine how the display panel 50 displays multi-view, three-dimensional video data and how users perceive the display of the multi-view, three-dimensional video data. In another embodiment, the range of depth (Z-axis) supported by the display panel 50 can be defined by the disparity between the three-dimensional video data for users' left and right eyes. These display parameters may to be collected by controller module collector 22.

Additionally, in an embodiment, the display panel 50 for displaying multi-view, three-dimensional video data may be a stereoscopic type display panel using a parallax barrier method. In this embodiment, the brightness of the display panel may be reduced as the number of viewpoints of the three-dimensional video data increases. In order to provide uniform and constant brightness level for the whole display panel 50, the backlight module of the display panel 50 may provide local dimming. When the display panel 50 displays three-dimensional image (within a three-dimensional field) and two-dimensional image simultaneously, the brightness of the backlight provided to the pixels within the three-dimensional field may be higher than the brightness provided to the pixels outside of the three-dimensional field of the display panel 50. The brightness adjustment may compensate the decreased brightness of the pixels within the three-dimensional field displaying the three-dimensional image. In another embodiment, when the display panel 50 displays three-dimensional images with different number of viewpoints (within different display fields) simultaneously, the brightness of the backlight provided to the pixels within a field displaying the three-dimensional images with more viewpoints may be higher than the brightness provided to the pixels within a field displaying the three-dimensional images with fewer viewpoints to compensate the decreased brightness of the pixels displaying the three-dimensional image with more viewpoints. In this embodiment, the type of the backlight module (e.g., edge type or direct type) of the display panel 50, its control algorithm and the format of the control signal provided to control the backlight module are all the display parameters to determine how the display panel 50 displays the multi-view, three-dimensional video data. These are display parameters may be collected by the controller module collector 22.

In an embodiment, the video player system 100 directly controls the display panel 50. In this embodiment, the controller module collector 22, through the hardware interface of the display panel 50 (e.g., DVI, DisplayPort, HDMI or USB interface, as described above), gathers the display parameters of the display panel 50 from the storage media within the display panel 50. In another embodiment, the controller module collector 22 includes an embedded look-up table listing the manufacturers and the model numbers of commercially sold display panels and the display parameters associated with to each commercially sold display panel. In this embodiment, the controller module collector 22 collects the display parameters associated with the display panel 50 by gathering the information related to the manufacturer and/or the model number of the display panel 50 and then, checking the embedded look-up table after gathering. In still another embodiment, the video player system 100 may be operated by an operating system and the video playback function may be performed by executing a software application. In this embodiment, the controller module collector 22 collects the display parameters, the manufacturer and/or the model number of the display panel 50, through Application Program Interface (API) of the operating system or the display parameter gathering function provided by the driver of the display panel 50.

In addition to the controller module collector 22, the display parameter collector module 20 of FIG. 2 further includes a UI (user interface) collector 24 for users to manually input the information related to the manufacturer and/or model number of the display panel 50, or the display parameters associated with the display panel 50. When the controller module collector 22 cannot collect a complete set of all the display parameters associated with the display panel 50, users can manually input the information related to the rest of the display parameters, the manufacturer, or the model number of the display panel 50 through the UI collector 24. Referring to FIG. 2, in an embodiment, a menu listing the manufacturer and/or the model number of commercially sold display panels may be displayed on the display panel 50 for users to select the proper option associated with the currently used display panel 50 through an user interface 60, so that the UI collector 24 can collect the display parameters associated with the display panel 50 by checking the embedded look-up table. In another embodiment, the testing images are displayed in different display modes on the display panel 50 for users, after seeing these testing images displayed in different modes, to manually select a proper display mode through an user interface 60, so that the UI collector 24 can collect the display parameter related to the display mode supported by the currently used display panel 50. Still in another embodiment, the testing images for both left and right eyes are displayed with different disparities on the display panel 50 for users, after seeing these testing images displayed with different disparities, to select the ones they perceive with comfort through an user interface 60, so that the UI collector 24 can collect the display parameter related to the proper range of the depth (Z-axis) supported by the currently used display panel 50.

The display parameter collector module 20 may further include the display parameter storage 26 for storing the display parameter gathered from either the controller module collector 22 or the UI collector 24. In an embodiment, the display parameter storage 26 includes a hard-disc or a flash. With the display parameter storage 26, the video display system 100 does not need to repeat the display parameter collection operation described above when the video player system 100 may be rebooted or used to display other multi-view, three-dimensional video data. In another embodiment, when an external device, such as a network server, requests the video player system 100 to provide the display parameters associated with the display panel 50, the video player system 100, upon receiving the request, sends the display parameters from the display parameter storage 26 to the network server in the format consistent with the internet protocol.

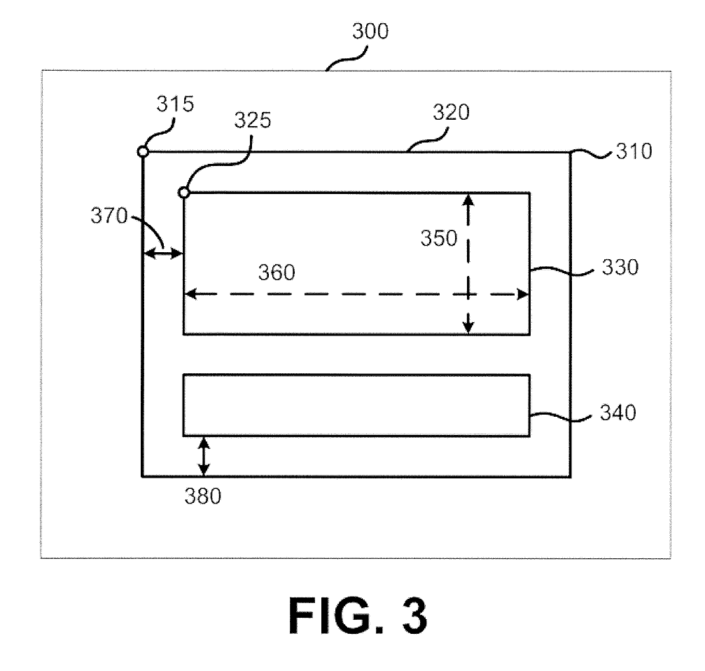

FIG. 3 illustrates an exemplary of the operation of a dynamic three-dimensional field detector and controller consistent with the disclosed embodiments. The video player system 100 of FIG. 2 further includes a dynamic three-dimensional field detector and controller module 30 for dynamically detecting the location and the area of three-dimensional field within the image of the received video data and providing a detection signal to the display recomposition module 40 and a control signal to the display panel 50, accordingly. In an embodiment, the video player system 100 may be operated by an operating system. The video play function may be performed by executing a software application. Referring to FIG. 3, the video data received by the video player system 100 includes at least an image 300. The image 300 is for displaying on the whole screen of the display panel 50. In this embodiment, when the video play function is performed, the image 300 displayed on the screen of the display panel 50 includes a display window 310. Referring to FIG. 3, the display window 310 further includes an outer frame 320, a three-dimensional field 330 for displaying multi-view, three-dimensional video data, and a control menu 340 for inputting commands to control the video display function. In this embodiment, the dynamic three-dimensional field detector and controller module 30 gathers the information related to the size and the location of the three-dimensional field 330 by gathering the information related to the on-screen coordination of the starting point 325, the height 350, and the width 360 of the three-dimensional field 330 through API of the operating system 70. The location and area of the three-dimensional field 330 for displaying multi-view, three-dimensional video data within the image 300 can thus be determined. In another embodiment, the dynamic three-dimensional field detector and controller module 30 gathers the information related to the size and the location of the three-dimensional field 330 by determining the on-screen coordination of the starting point 315, the horizontal displacement 370, and the vertical displacement 380 of the outer frame 320 through API of the operating system 70. The location and area of the three-dimensional field 330 for displaying multi-view, three-dimensional video data with the image 300 can thus be determined.

Furthermore, in an embodiment, users, the operation system and/or the software application can dynamically change the location and area of the three-dimensional field 330 within the image 300. In this embodiment, the dynamic three-dimensional field detector and controller module 30 may continuously or periodically detect the change of the location and the area of the three-dimensional field 330 within the image 300 once a change is occurred and then sends the detection signal corresponding to the change to the display recomposition module 40 and the control signal corresponding to the change to the display panel 50, respectively.

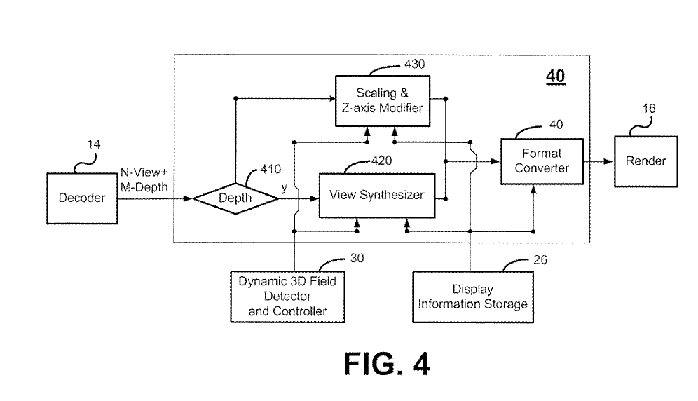

FIG. 4 illustrates a function block diagram of an exemplary of a display recomposition module consistent with the disclosed embodiments. As described above, when the resolution of the image 300 received by the video player system 100 may be different from the resolution of the display panel 50, the rows and the columns of the image 300 may be scaled based on the resolution of the display panel 50. Moreover, the depth (Z-axis) of the image 300 with the three-dimensional field 330 also may be adjusted. The depth adjustment may be based on not only the size and the resolution of the display panel 50 and its hardware capability, but also users' experience. In an embodiment, the display recomposition module 40 of the video player system 100 is for providing proper depth to the multi-view, three-dimensional video data of the three-dimensional field 330 so that users can comfortably see the display of the multi-view, three-dimensional video data in the three-dimensional field 330 without feeling dizzy.

In an embodiment, the display recomposition module 40 further includes a depth detection module 410, a view synthesizer 420, a scaling & Z-axis modifier 430, and a pixel arrangement generator 440. Referring to FIG. 4, the decoder 14 outputs the decompressed image 300 with three-dimensional field to the depth detection module 410 of the display recomposition module 40. The depth detection 410 detects whether the three-dimensional field within the decompressed image includes a depth map with depth information. It should be noted that not all the currently used video data encoding/decoding standards includes depth map encoding/decoding algorithm. Even if the multi-view, three-dimensional video data of the three-dimensional field 330 includes a depth map with M depth information, for example MPEG-4 MVC with MPEG-C part 3 to take Depth map as Auxiliary Video Data, the viewpoints of the multi-view, three-dimensional video data of the three-dimensional field 330 may be different from the viewpoints supported by the display panel 50. In an embodiment, the decompressed multi-view, three-dimensional video data of the three-dimensional field 320 within the image 300 may be sent to the view synthesizer 420 for scaling the resolution and the depth of the decompressed multi-view, three-dimensional video data of the three-dimensional field 330 based on at least one of the display parameters associated with the display panel 50 such as the size, the native resolution, and the proper range of depth (Z-axis) supported by the display panel 50. Also, in this embodiment, the view synthesizer 420 synthesizes the viewpoints of the decompressed three-dimensional video data of the three-dimensional field 330 based on the viewpoints supported by the display panel 50 and the detection signal associated with the area and the location of the three-dimensional field 330 within the image 300.

It should be noted that the conventional view synthesizer generates the viewpoints of the three-dimensional video data based on the multi-view, three-dimensional video data to be displayed on the whole screen of the display panel. However, the view synthesizer 420 in this embodiment synthesizes the viewpoints of the three-dimensional video data, which may be displayed on a portion of the display panel screen. As described above, the view synthesizer 420 in the embodiment synthesizes the viewpoints based on the display parameters associated with the display panel 50, as well as the detection signal representing the location and the area of the three-dimensional field 330 within the image 300. In this embodiment, the display panel 50 may display the multi-view, three-dimensional video data within the three-dimensional field 330 and the two-dimensional video data out of the three-dimensional field 330 of the image 300 simultaneously.

As described above, users, the operation system, and/or the software application can change the area and/or the location of the three-dimensional field 330 within the image 300. Thus, the view synthesizer 420 may synthesize the viewpoints of the three-dimensional video data of the three-dimensional field 330 based on the detection signal dynamically detected and provided by the dynamic three-dimensional field detector and controller module 30.

If the decompressed multi-view, three-dimensional video data of the three-dimensional field does not include depth information, it may be sent to the scaling & Z-axis modifier 430 of the display recomposition module 40. In an embodiment, the scaling & Z-axis modifier 430, upon receiving the detection signal provided by the dynamic three-dimensional field detector and controller module 30 indicating the location and the area of the three-dimensional field 330 within the image 300 and the display parameters collected and stored by the display parameter collector 20, may adjust the resolution of the images with three-dimensional field and the depth (Z-axis) of the three-dimensional field with multi-view, three-dimensional video data according to the size of the display panel 50, the native resolution of the display panel 50, and the resolution of the three-dimensional field to be displayed on the display panel 50, and proper range of the depth (Z-axis) supported by the display panel 50 so that users can comfortably observe the display of the multi-view, three-dimensional video data in the three-dimensional filed 330 within the image 300.

The image 300 with the recomposed multi-view, three-dimensional video data of the three-dimensional field 330 generated by either the view synthesizer 420 or the scaling & Z-axis modifier 430 may be provided to the pixel arrangement generator 440 for generating the data associated with each pixel of the display panel 50 based on the pixel arrangement supported by the display panel 50. In an embodiment, the pixel arrangement supported by the display panel 50 may be one of the display parameters associated with the display panel 50 and may be provided by the display parameter storage 26, as shown in FIG. 4.

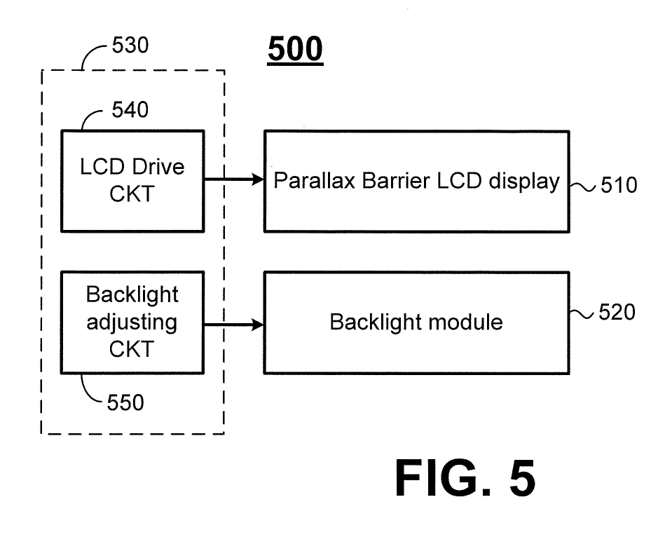

FIG. 5 illustrates a functional block diagram of an exemplary of a display panel consistent with the disclosed embodiments. In an embodiment, the display panel 500 further includes a LCD display 510 displaying image 300 with the three-dimensional field 330 in a parallax barrier method; a backlight module 520 for providing backlight with uniform and constant brightness level to the whole LCD display 510; and a control module 530 including a LCD driver circuit 540 for driving the pixels of the LCD display 510 and a backlight adjusting circuit 550 for adjusting the brightness level of backlight provided to each pixel of the LCD display 510 by performing a local dimming backlight method. As described above, for parallax barrier LCD display panel 510, the brightness of the display panel lowers as the number of viewpoints of the three-dimensional video data increases. Thus, in order to keep uniform and constant brightness level to the whole LCD display 510, the backlight module 520 may be able to perform local dimming backlight method.

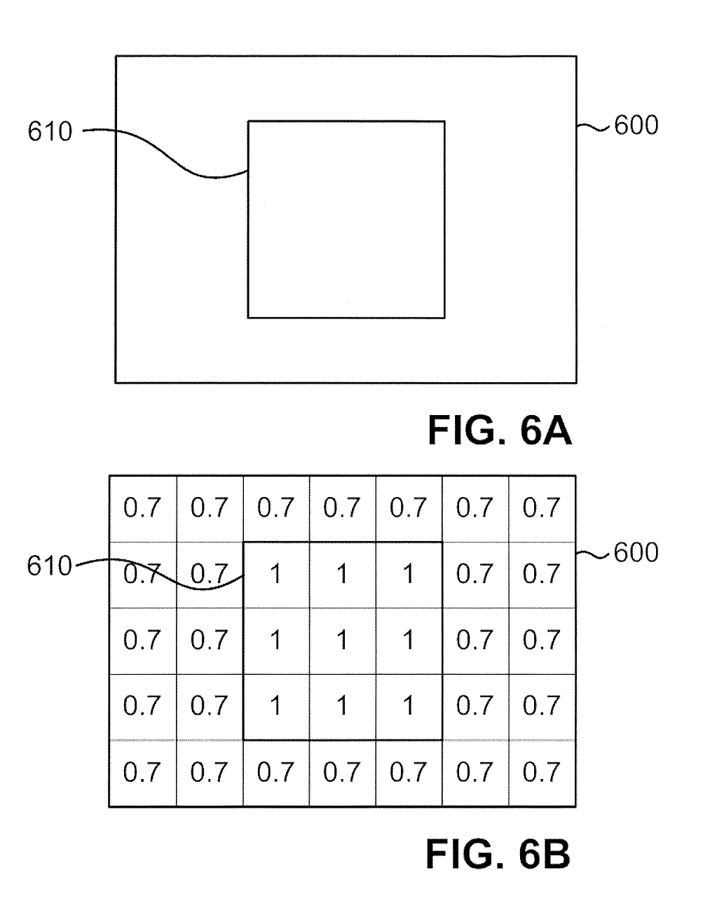

FIGS. 6A and 6B illustrate the operation of an exemplary of the local dimming backlight module consistent with the disclosed embodiments. When the LCD display 510 displays a multi-view, three-dimensional video data (within a three-dimensional field 610) and a two-dimensional image (out of the three-dimensional field 610) within the image 300 simultaneously, the brightness level of the backlight provided to the pixels within the three-dimensional field 610 may be larger than that provided to the pixels out of the three-dimensional field 610 of the LCD display 510 to compensate the decreased brightness of the pixels within the three-dimensional field 610 for displaying the multi-view, three-dimensional video data. As shown in FIG. 6B, in this embodiment, the brightness level (“1”) of the backlight provided to the pixels within the three-dimensional field 610 may be higher than the brightness level (“0.7”) of the backlight provided to the pixels out of the three-dimensional field 610. Thus, the decreased brightness of the pixels within the three-dimensional field 610 for displaying multi-view, three-dimensional video data may be compensated, so that the brightness level of all the pixels of the LCD display 510 remains uniform and constant.

In an embodiment, after detecting the location and the area of the three-dimensional field 330 within the image 300, the dynamic three-dimensional field detector and controller module 30 sends a control signal to the backlight adjusting circuit 550 of FIG. 5 to control the brightness level of the backlight provided to each pixel of the display panel 500. As described above, users, the operation system, and/or the software application can change the location and the area of the three-dimensional field 330 within the image 300. In this embodiment, the dynamic three-dimensional field detector and controller module 30 dynamically detects the change once it occurs and sends a control signal associated with the change to the backlight adjusting circuit 550 for adjusting the brightness level of the backlight provided to each pixel of the LCD display 510 to keep the uniform and constant brightness of all the pixels of the LCD display 510.

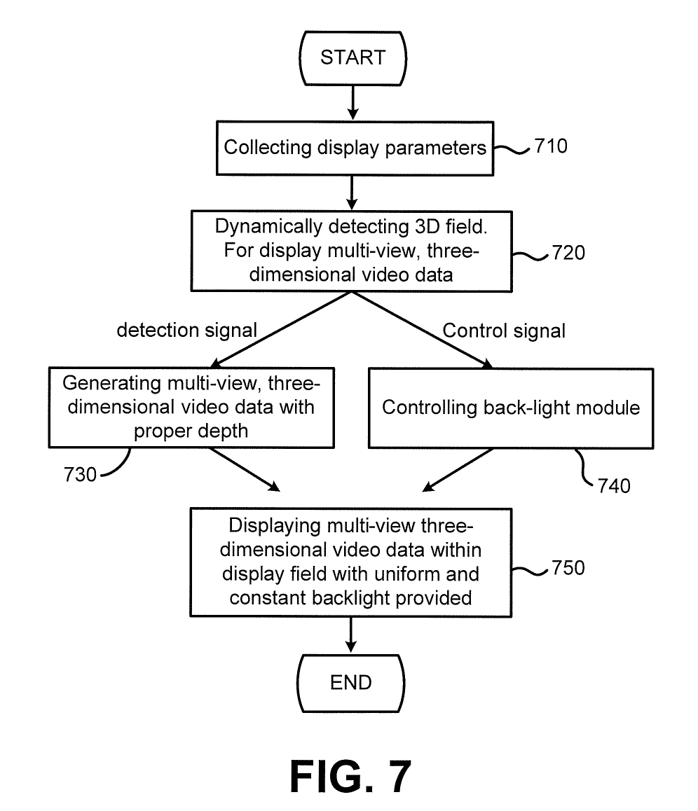

FIG. 7 illustrates a flow chart of an exemplary method for dynamically detecting and displaying multi-view, three-dimensional video data consistent with the disclosed embodiments. In an embodiment, the method performed by the video player system 10 for dynamically detecting and displaying multi-view, three-dimensional video data includes the following steps. In step 710, the display parameters associated with the display panel 50 may be collected by the display parameter collector module 20. As described above, the display parameters determine how the display panel 50 displays multi-view, three-dimensional video data. In an embodiment, the display parameters includes the display mode supported by the display panel 50, the maximum number of viewpoints supported by the display panel 50, the pixel arrangement of the multi-view, three-dimensional video data supported by the display panel 50, the proper range of depth (Z-axis) supported by the display panel 50 for displaying the multi-view, three-dimensional video data, the size and the native resolution of the display panel 50, the control algorithm to control the backlight module of the display panel 50, and the format of the control signal to control backlight module of the display panel 50.

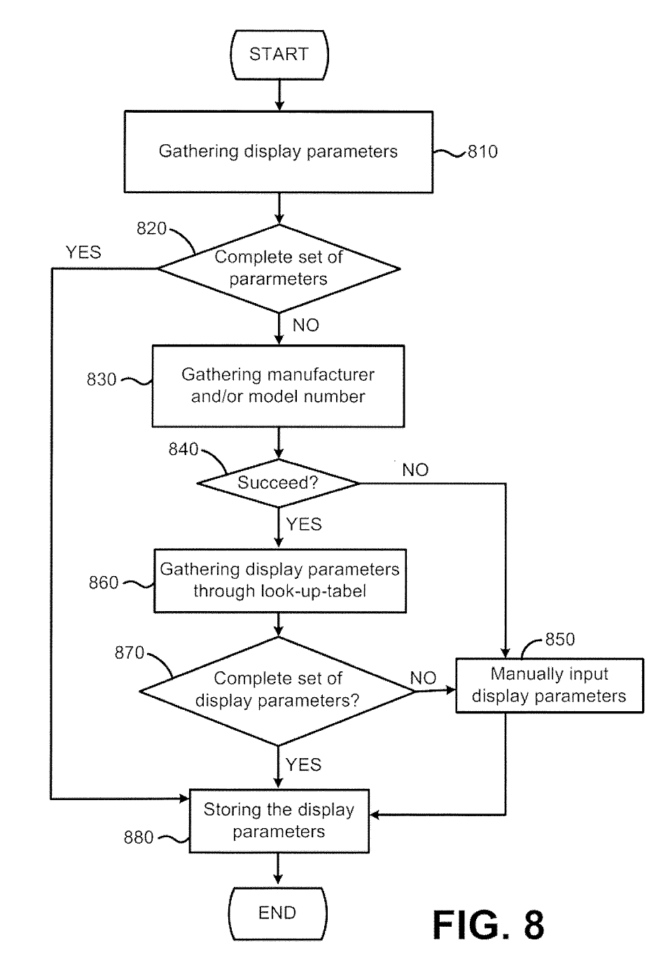

FIG. 8 illustrates a flow chart of an exemplary method for collecting display parameters consistent with the disclosed embodiments. An embodiment of a method for collecting display parameters includes the following steps. In step 810, the controller module collector 22 collects the display parameters of the display panel 50 from the display panel 50. As described above, if the video player system 100 directly controls the display panel 50, the display parameters can be gathered through the hardware interface of the display panel 50 (e.g., DVI, HDMI or USB interface). If the video player system 100 may be operated by an operating system and the video display function may be performed by executing a software application, the display parameters can be gathered through API of the operating system or the display parameter gathered function provided by the driver of the display panel 50.

In step 820, the display parameter collector 20 determines whether the gathered display parameters are a complete set. If the complete set of the display parameters is gathered, the display parameter collector 20 may perform step 880 to store the complete set of the display parameters into the display parameter storage 26. If the gathered display parameters are not a complete set, the controller module collector 22 may perform step 830 to gather the manufacturer and/or model number of the display panel 50. In step 840, the display parameter collector 20 determines whether the manufacturer and/or model number of the display panel 50 is successfully gathered. If it is the case, the collector module collector 22 may perform step 860 to gather the rest of the display parameters by checking the embedded look-up table. If the manufacturer or model number of the display panel 50 is not successfully gathered, or the display parameters gathered through embedded look-up table are still not a complete set, the UI collector 24 may perform step 850 for users to manually input the information related to the remaining display parameters associated with the display panel 50. Several embodiments of the operation of the UI collector 24 are described above. In step 880, all the display parameters associated with the display panel 50 and gathered by either the controller module collector 22 or the UI collector 24 are stored in the display parameters storage 26.

Referring to FIG. 7, after the step 710 is performed, the dynamic three-dimensional field detector and controller 30 may perform step 720 to dynamically detect the area and the location of the three-dimensional display field 330 within the image 300.

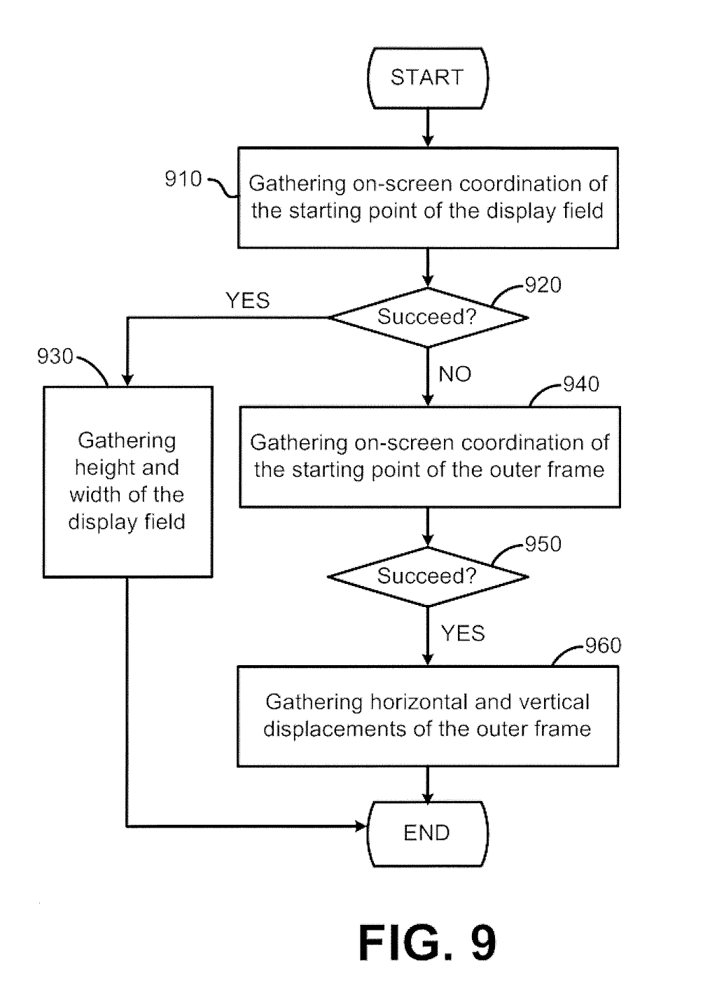

FIG. 9 illustrates a flow chart of an exemplary method for dynamically detecting a three-dimensional field within the image consistent with the disclosed embodiments. In an embodiment, the video player system 10 is operated by an operating system and the video display function may be performed by executing an application program. Referring to FIG. 3, the received vide data includes at least an image 300 and the image 300 further includes a three-dimensional field 330 for displaying the multi-view, three-dimensional video data. When video play function is performed, a display window is shown on the screen of the display panel 50. In this embodiment, the display window 310 further includes an outer frame 320, a three-dimensional field 330 for displaying multi-view, three-dimensional video data, and a control menu 340 for inputting commands to control the video display function. When the image 300 with the three-dimensional field 330 is received by the video player system 100, the dynamic three-dimensional field detector and controller module 30 performs step 910 to gather the information related to the on-screen coordination of the starting point 325 of the three-dimensional field 330 through API of the operating system. In step 920, the dynamic three-dimensional field detector and controller module 30 determines whether the on-screen coordination of the starting point 325 of the three-dimensional field 330 is successfully gathered. If it is the case, the step 930 is performed to gather the information related to the height 350 and the width 360 of the three-dimensional field 330 through API of the operating system. The location and the area of the three-dimensional field 330 within the image 300 can thus be determined.

If the information related to the on-screen coordination of the starting point 325 of the three-dimensional field 330 is not successfully gathered, the dynamic three-dimensional field detector and controller module 30 may perform step 940 to gather the information related to the on-screen coordination of the starting point 315 of the outer frame 320 through API of the operating system. In the step 950, the dynamic three-dimensional field detector and controller module 30 may determine whether the information related to the on-screen coordination of the starting point 315 of the outer frame 320 is successfully gathered. If it is the case, the dynamic three-dimensional field detector and controller module 30 may perform step 960 to gather the information related to the horizontal displacement 370 and the vertical displacement 380 of the outer frame 320 through API of the operating system. Thus, the location and area of the three-dimensional field 330 within the image 300 can thus be determined.

Referring to FIG. 7, after the step 720 is performed, the dynamic three-dimensional field detector and controller 30 sends a detection signal corresponding to the area and the location of the three-dimensional field 330 within the image 300 to the display recomposition module 40. In step 730, the display recomposition module 40 generates the multi-view, three-dimensional video data with proper depth and required viewpoints based on the display parameters associated with the display panel 50 for users to comfortably observe the display of the multi-view, three-dimensional video data in a three-dimensional field 330 on the screen of the display panel 50 without feeling dizzy.

Meanwhile, the dynamic three-dimensional field detector and controller 30 may send a control signal to the backlight adjusting circuit of the display panel. In step 740, the backlight adjusting circuit may control the local dimming backlight module to keep uniform and constant brightness level to the whole LCD display 510. The detail of the operation of the local dimming backlight module is described above.

The step 750 may be performed. In this embodiment, the multi-view, three-dimensional video data of the three-dimensional field 330 and the two-dimensional video data (based on the three-dimensional field 330 of the image 300) may be displayed simultaneously. Also, the backlight module, under the control of the backlight adjusting circuit, may provide backlight with higher brightness level to the pixels within the three-dimensional field 330 and may provide backlight with lower brightness level to the pixels out of the three-dimensional field 330 to compensate the decreased brightness level of the pixels displaying the multi-view, three-dimensional video data. Thus, the backlight module in this embodiment may provide substantially more uniform (or visually uniform) brightness level to the whole display panel.

When the area and the location of the three-dimensional field 330 within the image 300 is changed, the dynamic three-dimensional field detector and controller may perform the step 720 to dynamically detect the change and send the detection signal associated with the change to the display recomposition module 40 and the control signal associated with the change to the backlight adjusting circuit of the display panel. The display recomposition module may perform the step 730 to generate the multi-view, three-dimensional video data of the three-dimensional field 330 with proper depth and required viewpoints in response to the change. Meanwhile, the backlight adjusting circuit may perform the step 740 to adjust the brightness level of the backlight provided to each pixel of the display panel 50 in response to the change.

The step 750 may be performed so that the three-dimensional field 330 may be displayed at a new location or a new area on the screen of the display panel 50. Also, the backlight module under the control of the backlight adjusting circuit, in response to display at the new area or location, may provide backlight with different brightness level to different pixels (or different groups of pixels) of the display panel to maintain a substantially more uniform (or visually uniform) brightness level to the whole display panel 50.

It will be apparent to those skilled in the art that various modifications and variations can be made in the disclosed process without departing from the scope or spirit of the disclosed embodiments. Other embodiments will be apparent to those skilled in the art from consideration of the specification and practice of the disclosed embodiments. It is intended that the specification and examples be considered as exemplary only, with a true scope and spirit of the disclosed embodiments identified by the following claims.

What is claimed is:

1. A video player system comprising:
a three-dimensional field detector and controller module for detecting a three-dimensional field within at least one image of video data to generate at least one of a detection signal and a control signal based on the three-dimensional field detected, wherein the video data includes data for at least one image and the three-dimensional field within the image; and
a display recomposition module coupled with the three-dimensional field detector and controller module, the display recomposition module generating a recomposed three-dimensional field within the at least one image based on the detection signal and at least one of a plurality of display parameters associated with a display panel,
wherein the three-dimensional field detector and controller module and the display recomposition module are coupled with the display panel for displaying the at least one image with the recomposed three-dimensional field based on at least one of the control signal and at least one of the plurality of display parameters.

2. The system of claim 1, wherein the three-dimensional field comprises a multi-view, three-dimensional video data.

3. The system of claim 1, wherein the video player system further comprises a video data player module coupled with a source for providing the at least one image with the three-dimensional field, wherein the video data player module processes the at least one image with the three-dimensional field received from the source and outputs a processed with the three-dimensional field to the display recomposition module.

4. The system of claim 3, wherein the video data player module further includes a decoder for decoding the at least one image with the three-dimensional field received in a compressed form.

5. The system of claim 1, wherein the video player system further comprises a display parameter collector module coupled with the display panel and the display recomposition module, the display parameter collector module collecting the plurality of display parameters and providing the at least one of the plurality of display parameters to the display recomposition module.

6. The system of claim 5, wherein the display parameter collector module receives manually-input parameter information relating to at least one of the plurality of display parameters.

7. The system of claim 6, wherein the manually-input parameter information includes at least one of a manufacturer and a model number associated with the display panel.

8. The system of claim 1, wherein the plurality of display parameters includes at least one of a display mode supported by the display panel, a viewpoint number supported by the display panel, a pixel arrangement of a three-dimensional field supported by the display panel, a range of depth (Z-axis) supported by the display panel for displaying the three-dimensional field, a size of the display panel, and a resolution of the display panel.

9. The system of claim 8, wherein the display panel includes a control module coupled with the three-dimensional field detector and controller module, the control module controlling the display panel that displays the at least one image with the recomposed three-dimensional field based on the control signal provided by the three-dimensional field detector and controller module.

10. The system of claim 9, wherein the control module is a backlight module for providing backlight to the display panel.

11. The system of claim 10, wherein the display panel is a parallax barrier type display panel.

12. The system of claim 11, wherein the backlight module of the display panel is a local dimming backlight module for providing localized backlight control for each group of at least one pixel of the display panel based on the group location on the display panel.

13. The system of claim 1, wherein the three-dimensional field detector and controller module dynamically detects at least one of an area and a location of the three-dimensional field within the at least one image.

14. The system of claim 1, wherein the display recomposition module generates a recomposed three-dimensional field within the at least one image by scaling a resolution of the at least one image and adjusting a depth of the three-dimensional field within the at least one image based on at least one of the control signal and the display parameter.

15. The system of claim 14, wherein the display parameter includes at least one of a range of depth (Z-axis) supported by the display panel for displaying the three-dimensional field, a size of the display panel, and a resolution supported by the display panel.

16. The system of claim 14, wherein the display recomposition module generates a recomposed three-dimensional field within the at least one image by synthesizing a plurality of viewpoints of the three-dimensional field based on at least one of the detection signal and the display parameter.

17. The system of claim 16, wherein the display parameter includes the number of viewpoints supported by the display panel.

18. The system of claim 14, wherein the display recomposition module generates a recomposed three-dimensional field within the at least one image by arranging the three-dimensional field within the at least one image based on a pixel arrangement supported by the display panel.

19. A method for displaying video data, the method comprising:
detecting a three-dimensional field within a at least one image of a video data to generate at least one of a detection signal and a control signal based on the three-dimensional field detected; and
generating a recomposed three-dimensional field within the at least one image based on the detection signal and at least one of a plurality of display parameters associated with a display panel,
wherein the display panel displays the at least one image with the recomposed three-dimensional field based on at least one of the control signal and the plurality of display parameters.

20. The method of claim 19, wherein the three-dimensional field comprises a multi-view, three-dimensional video data.

21. The method of claim 19, wherein the method further comprises:
receiving the at least one image with the three-dimensional field;
processing the at least one image with the three-dimensional field; and
providing the at least one image with the three-dimensional field for recomposing.

22. The method of claim 21, wherein processing the at least one image with the three-dimensional field further includes decoding the at least one image with the three-dimensional field received in a compressed form.

23. The method of claim 19, wherein the method further comprises collecting the plurality of display parameters associated with the display panel.

24. The method of claim 23, wherein collecting the plurality of display parameters associated with the display panel further includes receiving a manually-input parameter information relating to at least one of the plurality of display parameters.

25. The method of claim 24, wherein the manually-input parameter information includes at least one of a manufacturer and a model number associated with the display panel.

26. The method of claim 19, wherein the plurality of display parameters includes at least one of a display mode supported by the display panel, a viewpoint number supported by the display panel, a pixel arrangement of a three-dimensional field supported by the display panel, a range of depth (Z-axis) supported by the display panel for displaying the three-dimensional field, a size of the display panel, and a resolution of the display panel.

27. The method of claim 26, wherein the control signal is for controlling the display panel displaying the at least one image with the recomposed three-dimensional field.

28. The method of claim 27, wherein the control signal is for controlling backlight provided to the display panel.

29. The method of claim 28, wherein the display panel is a parallax barrier type display panel.

30. The method of claim 28, wherein the control signal is for controlling the localized backlight provided to each group of at least one pixel of the display panel based on the group location on the display panel.

31. The method of claim 19, wherein detecting the three-dimensional field within at least one image of a video data further includes dynamically detecting at least one of an area and a location of the three-dimensional field within the at least one image.

32. The method of claim 19, wherein generating the recomposed three-dimensional field within the at least one image further includes scaling a resolution of the at least one image and adjusting a depth of the three-dimensional field within the at least one image based on at least one of the control signal and the display parameter.

33. The method of claim 19, wherein the display parameter includes at least one of a range of depth (Z-axis) supported by the display panel for displaying the three-dimensional field, a size of the display panel, and a resolution supported by the display panel.

34. The method of claim 19, wherein generating the recomposed three-dimensional field within the at least one image further includes synthesizing a plurality of viewpoints of the three-dimensional field based on at least one of the detection signal and the display parameter.

35. The method of claim 34, wherein the display parameter includes the number of viewpoints supported by the display panel.

36. The method of claim 19, wherein generating the recomposed three-dimensional field within the at least one image further includes arranging the three-dimensional field with the at least one image based on a pixel arrangement supported by the display panel.

37. A video player system comprising:
a three-dimensional field detector module for detecting a three-dimensional field within at least one image of video data and generating at least one of a detection signal based on the three-dimensional field detected, wherein the video data includes data for at least one image and the three-dimensional field within the image; and
a display recomposition module coupled with the three-dimensional field detector and controller module, the display recomposition module generating a recomposed three-dimensional field within the at least one image based on the detection signal and at least one of a plurality of display parameters associated with a display panel,
wherein the three-dimensional field comprises a multi-view information associated with at least a portion of the video data, and the recomposed three-dimensional field is used for displaying the at least one image by the display panel.

38. The system of claim 37, wherein the video player system further comprises a video data player module coupled with a source for providing the at least one image with the three-dimensional field, wherein the video data player module processes the at least one image with the three-dimensional field received from the source and outputs a processed with the three-dimensional field to the display recomposition module.

39. The system of claim 37, wherein the plurality of display parameters includes at least one of a display mode supported by the display panel, a viewpoint number supported by the display panel, a pixel arrangement of a three-dimensional field supported by the display panel, a range of depth (Z-axis) supported by the display panel for displaying the three-dimensional field, a size of the display panel, and a resolution of the display panel.

40. The system of claim 37, wherein the display recomposition module generates a recomposed three-dimensional field within the at least one image by scaling a resolution of the at least one image and adjusting a depth of the three-dimensional field within the at least one image based on at least one of the control signal and the display parameter.

41. The system of claim 37, wherein the display recomposition module generates a recomposed three-dimensional field within the at least one image by synthesizing a plurality of viewpoints of the three-dimensional field based on at least one of the detection signal and the display parameter.
